(19) United States
(12) Patent Application Publication
(10) Pub. No.: US 2014/0291213 A1
(43) Pub. Date: Oct. 2, 2014

(54) PROCESS AND SYSTEM FOR DRY COAL SEPARATION BY COAL GANGUE REMOVAL

(71) Applicants: Bing Chen, Zi Bo City (CN); Shuliang Liu, Zi Bo City (CN); Kang Zhang, Zi Bo City (CN); Bobo Hou, Zi Bo City (CN)

(72) Inventors: Bing Chen, Zi Bo City (CN); Shuliang Liu, Zi Bo City (CN); Kang Zhang, Zi Bo City (CN); Bobo Hou, Zi Bo City (CN)

(73) Assignee: SHANGDONG BORUN PROCESS INDUSTRIAL TECHNOLOGY CORP. CO., LTD., Zi Bo City, ShanDong Province (CN)

(21) Appl. No.: 14/354,803

(22) PCT Filed: Jul. 3, 2012
(86) PCT No.: PCT/CN2012/000909

§ 371 Date: Apr. 28, 2014

(30) Foreign Application Priority Data
Oct. 27, 2011 (CN) 201110331999.4

(51) Int. Cl. B07B 9/02

(52) U.S. Cl. CPC B07B 9/02
USPC 209/44.2

(57) ABSTRACT

The process for coal separation includes two steps of size grading and oversize raw coal separating. A size range is obtained through size grading, then the obtained raw coal is separated by a sensor system, and coal briquettes with high impurity contents are blown into an impurity chamber through high-speed compressed air, thus improving the separating accuracy and efficiency. The system for coal separation includes a dry screening machine, an oversize raw coal conveying chute, a sensor system, a control system, nozzles and a flow division chamber. The tail end of the dry screening machine is connected with the charge end of the chute; the sensor system and the discharge end of the chute are correspondingly arranged; the flow division chamber is arranged below the chute; and the nozzles operated and controlled by the control system are arranged between the discharge end of the chute and the flow division chamber.

### FIELD OF THE INVENTION

The present invention relates to a process and system for dry coal separation by coal gangue removal, applicable to realize separation and upgrading of coal in places with water shortage.

### BACKGROUND OF THE INVENTION

Raw coal contains a number of non-coal substances, in which the substances with high ash contents, such as gangue and sulphur-containing salts can cause low calorific value of coal, so that the impurities with low calorific values need to be separated from coal to increase the calorific value of coal. Currently, coal separation methods for increasing the calorific value of coal by coal mining enterprises can be roughly divided into: dry separation and wet separation.

Wet separation: mixing raw coal and a medium density fluid utilizing magnetizing iron powder, and then separating based on the density difference between coal and gangue, and wet separation is complex in process, large in the quantity of design devices and high in investment and running cost.

However, the western China with water shortage is high in coal reserves and suitable for dry coal separation. Dry coal separation has the advantages of being low in investment, simple in process and low in running cost, however, the traditional dry separation process is low in production efficiency due to hand gangue separation, and great human factors exist in manual gangue separation, so that the accuracy and effect of separation can not be ensured; in order to improve the separation accuracy, separation is mostly performed by virtue of a wind cyclone according to densities, but all the raw coal containing gangue needs to be blown up by wind power in the coal separation process utilizing the wind cyclone, the mode is high in energy consumption, noise and dust, and does not comply with environmental requirements. Therefore, there is an urgent need to research and develop a dry coal separation process which is capable of ensuring separation accuracy and efficiency and is environmentally-friendly, economical and practical.

### SUMMARY OF THE INVENTION

The present invention aims at solving the defects of the coal separation processes above, and providing a process which is applicable to perform separation and upgrading on coal in places with water shortage, is capable of ensuring separation accuracy and efficiency, and is environmentally-friendly and low in energy consumption.

The present invention further aims at providing a system which is compact in structure and is capable of realizing the process for dry coal separation by coal gangue removal.

the technical scheme adopted by the present invention for solving the technical problems is as follows:

a process for dry coal separation by coal gangue removal, characterized by comprising the following steps:

(1) size grading: the needed size range of raw coal is determined as needed, raw materials are screened by a dry screening machine, the raw coal is divided into oversize raw coal and undersize raw coal after the size grading, the undersize raw coal is conveyed to other places through an undersize raw coal conveying device, and the oversize raw coal is the raw coal in the needed size range, and enters an identification area composed of a sensor system, a control system, nozzles and a flow division chamber through an oversize raw coal conveying chute;

(2) oversize raw coal separating: after the oversize raw coal enters the identification area, radiography and ingredient judgment are performed on the composition of the oversize raw coal by the sensor system, the perspective images and characteristics of coal briquettes will be presented due to the difference between the densities of the coal briquettes and the contents of impurities such as gangue, sulphur, iron and the like, the information is transmitted to the control system by the sensor system, the positions of the coal briquettes with high impurity contents are identified and the opening and closing of the nozzles at corresponding positions are controlled by the control system, high-speed compressed air is horizontally blown to the positions with the high impurity contents through the nozzles, the coal briquettes with the high impurity contents are blown into an impurity chamber of the flow division chamber, and needed products fall into a product chamber of the flow division chamber, so as to finish the oversize raw coal separating.

The undersize raw coal in the step (1) is separated by means of pneumatic separation or heavy medium density fluid coal separation.

The system for dry coal separation by coal gangue removal, characterized by comprising: a dry screening machine, an oversize raw coal conveying chute, a sensor system, a control system, nozzles and a flow division chamber, wherein an undersize raw coal conveying device is arranged below the dry screening machine; the tail end of the dry screening machine is connected with the charge end of the oversize raw coal conveying chute; the sensor system and the discharge end of the oversize raw coal conveying chute are correspondingly arranged; the flow division chamber is arranged below the oversize raw coal conveying chute; the nozzles operated and controlled by the control system are arranged between the discharge end of the oversize raw coal conveying chute and the flow division chamber; and the flow division chamber is composed of a product chamber and an impurity chamber which are arranged in parallel.

The sensor system is one of or a combination of more of an X-ray sensor, an ultrasonic sensor, a magnetic induction sensor, a visual sensor and a colour sensor, and is mainly used for identifying materials, wherein the unneeded coal with impurities is accurately identified from qualified coal by virtue of the sensor system.

The undersize raw coal conveying device is a belt conveyor or a chute.

The dry screening machine is a flip-flow screening machine.

The present invention has the following beneficial effects:

the system for dry coal separation by coal gangue removal in the present invention is compact in structure and small in occupied area; and the process for dry coal separation by coal gangue removal may be performed without the use of water resources and save water, and is especially applicable to the western China with high coal reserves. The process is simple and reliable due to the steps of obtaining a size range suitable for the market through size grading at first, and then separating the obtained raw coal; during separation, eyes for manual gangue separation are replaced by the sensor system, thus improving the separation accuracy, and the coal briquettes with high impurity contents are blown into the impurity chamber through high-speed compressed air, thus increasing the efficiency of gangue separation; and the quantity of the blown coal briquettes with high impurity contents during separation is small, so that effective air energy is used for the accurately-separated impurities through the nozzles, and then the process has the advantages of being low in air consumption, low in energy consumption and environment-friendly in comparison with the traditional pneumatic coal separation.

### BRIEF DESCRIPTION OF THE DRAWINGS

FIG. 1 is a structural schematic diagram of a system for dry coal separation by coal gangue removal of the present invention.

In the diagram:
1, flip-flow screening machine;
2, belt conveyer;
3, oversize raw coal conveying chute;
4, sensor system;
5, impurity chamber;
6, product chamber;
7, nozzles;
8, control system.

### DETAILED DESCRIPTION OF THE EMBODIMENTS

The embodiment of the present invention is further described below in conjunction with the accompanying drawing:

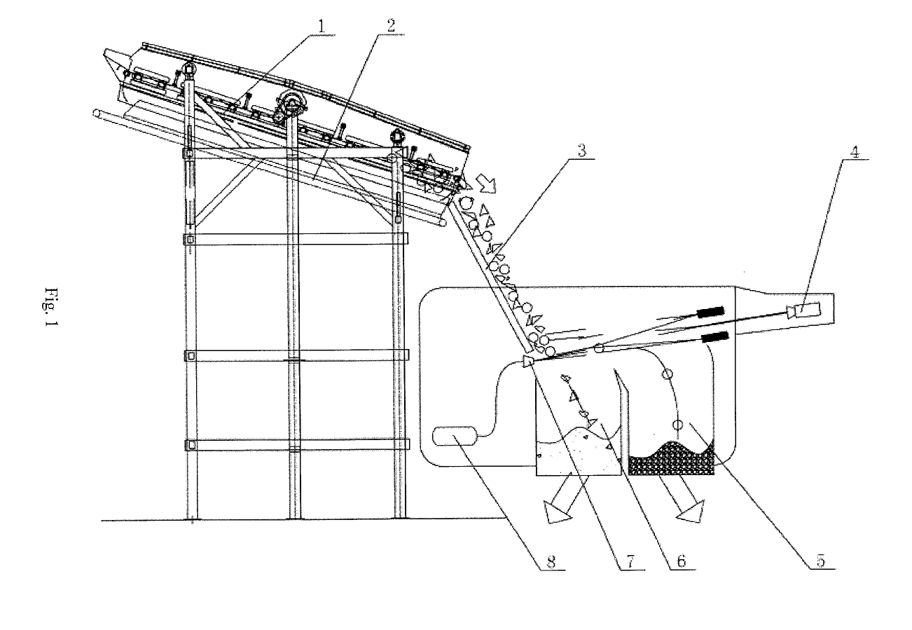

as shown in FIG. 1, the system for dry coal separation by coal gangue removal comprises a flip-flow screening machine 1, an oversize raw coal conveying chute 3, a sensor system, a control system 8, nozzles 7 and a flow division chamber, wherein a belt conveyer 2 used for conveying the oversize raw coal is arranged below the flip-flow screening machine 1, the tail end of the flip-flow screening machine 1 is connected with the charge end of the oversize raw coal conveying chute 3; the sensor system 4 and the discharge end of the oversize raw coal conveying chute 3 are correspondingly arranged; the flow division chamber is arranged below the oversize raw coal conveying chute 3; the nozzles 7 operated and controlled by the control system 8 are arranged between the discharge end of the oversize raw coal conveying chute 3 and the flow division chamber; and the flow division chamber is composed of a product chamber 6 and an impurity chamber 5 which are arranged in parallel, wherein the product chamber 6 is closer to the nozzles 7 compared with the impurity chamber 5.

The sensor system 6 is one of or a combination of more of an X-ray sensor, an ultrasonic sensor, a magnetic induction sensor, a visual sensor and a colour sensor. Radiography and ingredient judgment can be performed on the composition of materials by the sensor, the perspective images and characteristics of coal briquettes will be presented due to the difference between the densities of the coal briquettes and the contents of impurities such as gangue, sulphur, iron and the like, so that the positions of the coal briquettes with high impurity contents can be judged by the control system 8 according to the information fed back by the sensor.

Before separation, the needed size range of raw coal is determined as needed at first, raw materials are screened by the flip-flow screening machine 1, the raw coal is divided into oversize raw coal and undersize raw coal after size grading, the undersize raw coal is conveyed to other processes through the belt conveyer 2 and subjected to combined coal separation by means of pneumatic separation or heavy medium density fluid coal separation, and the obtained oversize raw coal is the raw coal in the needed size range; when the oversize raw coal falls from the discharge end of the oversize raw coal conveying chute 3, the sensor system 6 detects the oversize raw coal and feeds back a signal to the control system 8, the positions of the coal briquettes with high impurity contents are identified and the opening and closing of the nozzles 7 at corresponding positions are controlled by the control system 8, high-speed compressed air is horizontally blown to the positions with the high impurity contents through the nozzles 7, the coal briquettes with the high impurity contents are blown into the impurity chamber 5 far away from the discharge end of the oversize raw coal conveying chute 3, and needed products fall into the product chamber 6, so as to finish oversize raw coal separating.

The separation accuracy in the process depends on coal quality and the sensor system, and the process is strictly executed once the separation accuracy is set, so that human factors in the manual gangue separation process can be avoided, and the separation accuracy is high; a series of automatic devices is adopted in the whole process, so that the automation degree is high and the separation efficiency is high compared with the traditional hand gangue separation process; the energy consumption is low, the noise is low and the device size is small compared with the dry coal separation process utilizing a wind cyclone; and less dust is generated, environmental requirements are met better, and both the separation accuracy and the separation efficiency are greatly improved.

1. A process for dry coal separation by coal gangue removal, comprising the following steps:
(1) size grading: the needed size range of raw coal is determined as needed, raw materials are screened by a dry screening machine, the raw coal is divided into oversize raw coal and undersize raw coal after the size grading, the undersize raw coal is conveyed to other places through an undersize raw coal conveying device, and the oversize raw coal is the raw coal in the needed size range, and enters an identification area composed of a sensor system, a control system, nozzles and a flow division chamber through an oversize raw coal conveying chute;
(2) oversize raw coal separating: after the oversize raw coal enters the identification area, radiography and ingredient judgment are performed on the composition of the oversize raw coal by the sensor system, the perspective images and characteristics of coal briquettes will be presented due to the difference between the densities of the coal briquettes and the contents of impurities such as gangue, sulphur, iron and the like, the information is transmitted to the control system by the sensor system, the positions of the coal briquettes with high impurity contents are identified and the opening and closing of the nozzles at corresponding positions are controlled by the control system, high-speed compressed air is horizontally blown to the positions with the high impurity contents through the nozzles, the coal briquettes with the high impurity contents are blown into an impurity chamber of the flow division chamber, and needed products fall into a product chamber of the flow division chamber, so as to finish the oversize raw coal separating.

2. The process for dry coal separation by coal gangue removal of claim 1, wherein the undersize raw coal in the step (1) is separated by means of pneumatic separation or heavy medium density fluid coal separation.

3. A system for dry coal separation by coal gangue removal, comprising a dry screening machine, an oversize raw coal conveying chute, a sensor system, a control system, nozzles and a flow division chamber, wherein an undersize raw coal conveying device is arranged below the dry screening machine; the tail end of the dry screening machine is connected with the charge end of the oversize raw coal conveying chute; the sensor system and the discharge end of the oversize raw coal conveying chute are correspondingly arranged; the flow division chamber is arranged below the oversize raw coal conveying chute; the nozzles operated and controlled by the control system are arranged between the discharge end of the oversize raw coal conveying chute and the flow division chamber; and the flow division chamber is composed of a product chamber and an impurity chamber which are arranged in parallel.

4. The system for dry coal separation by coal gangue removal of claim 3, wherein the sensor system is one of or a combination of more of an X-ray sensor, an ultrasonic sensor, a magnetic induction sensor, a visual sensor and a colour sensor.

5. The system for dry coal separation by coal gangue removal of claim 3, wherein the undersize raw coal conveying device is a belt conveyor or a chute.

6. The system for dry coal separation by coal gangue removal of claim 3, wherein the dry screening machine is a flip-flow screening machine.

7. The system for dry coal separation by coal gangue removal of claim 4, wherein the dry screening machine is a flip-flow screening machine.

8. The system for dry coal separation by coal gangue removal of claim 5, wherein the dry screening machine is a flip-flow screening machine.
